(19) United States
(12) Patent Application Publication
(10) Pub. No.: US 2024/0408901 A1
(43) Pub. Date: Dec. 12, 2024

(54) INK-JET RECORDING APPARATUS

(71) Applicant: KYOCERA Document Solutions Inc., Osaka (JP)

(72) Inventor: Takahito MORITA, Osaka (JP)

(73) Assignee: KYOCERA Document Solutions Inc., Osaka (JP)

(21) Appl. No.: 18/731,888

(22) Filed: Jun. 3, 2024

(30) Foreign Application Priority Data
Jun. 7, 2023 (JP) 2023-093988

(51) Int. Cl. B41J 25/308; B41J 2/045; B41J 13/076

(52) U.S. Cl. CPC B41J 25/3082; B41J 2/0457; B41J 13/076

(57) ABSTRACT

An ink-jet recording apparatus includes a conveying unit, a recording head, a head housing, and a guide rail. The recording head includes an ink ejection surface provided with a plurality of nozzles which ejects ink toward the recording medium conveyed by the conveying unit. The head housing holds the recording head. The guide rail supports the head housing so that the head housing can reciprocate with respect to the conveying belt. The ink ejection surface is parallel to a conveying surface of the conveying belt. Moreover, the ink ejection surface is inclined with respect to a horizontal direction in a cross section orthogonal to an axial direction of the conveying roller. By moving the head housing along the guide rail extending in the horizontal direction, the ink ejection surface reciprocates between a printing position close to a conveying surface and a maintenance position retracted from the conveying surface.

### INCORPORATION BY REFERENCE

This application is based on and claims the benefit of priority from Japanese Patent Application No. 2023-093988 filed on Jun. 7, 2023, the contents of which are hereby incorporated by reference.

### BACKGROUND

The present disclosure relates to an ink-jet recording apparatus.

A conventional ink-jet recording apparatus includes a conveying unit, a recording head, a head housing, and a guide rail. The conveying unit includes a conveying belt which conveys a recording medium. The recording head includes an ink ejection surface provided with a plurality of nozzles which ejects ink onto the recording medium conveyed by the conveying unit. The head housing holds the recording head. The guide rail supports the head housing so that the head housing can be retracted from the conveying belt. The ink ejection surface is parallel to a conveying surface of the conveying belt. By moving the head housing along the guide rail extending in an up-and-down direction, the ink ejection surface reciprocates between a printing position close to a conveying surface and a maintenance position retracted from the conveying surface.

When the prior art is adopted, there is a possibility the head housing will be upsized in the up-and-down direction since the head housing moves in the up-and-down direction.

In the light of the above-described problems, the object of the present disclosure is to provide an ink-jet printing apparatus that can be downsized.

### SUMMARY

An ink-jet recording apparatus according to one aspect of the present disclosure includes a conveying unit, a recording head, a head housing, and a guide rail. The conveying unit includes a conveying belt which conveys a recording medium, and a conveying roller over which the conveying belt is stretched. The recording head includes an ink ejection surface provided with a plurality of nozzles which ejects ink onto the recording medium conveyed by the conveying unit. The head housing holds the recording head. The guide rail supports the head housing so that the head housing can reciprocate with respect to the conveying belt. The ink ejection surface is parallel to a conveying surface of the conveying belt. Moreover, the ink ejection surface is inclined with respect to a horizontal direction in a cross section orthogonal to an axial direction of the conveying roller. By moving the head housing along the guide rail extending in the horizontal direction, the ink ejection surface reciprocates between a printing position close to the conveying surface and a maintenance position retracted from the conveying surface.

This and other objects of the present disclosure, and the specific benefits obtained according to the present disclosure, will become apparent from the description of embodiments which follows.

### BRIEF DESCRIPTION OF THE DRAWINGS

FIG. 1 is a schematic cross-sectional view illustrating an overall configuration of a printer 100 as an ink-jet recording apparatus according to one embodiment of the present disclosure.

FIG. 2 is a plan view illustrating a first conveying unit 5 and a recording unit 9 in the printer 100.

FIG. 3 is a side view illustrating recording heads 17a to 17c constituting line heads 11C to 11K of the recording unit 9 in the printer 100.

FIG. 4 is a plan view illustrating the recording head 17a to 17c in the printer 100 viewed from an ink ejection surface F side.

FIG. 5 is a perspective diagram illustrating a part of the first conveying unit 5 and recording unit 9 in the printer 100.

FIG. 6 is an explanatory diagram illustrating an operation of the recording unit 9 with respect to the first conveying unit 5 in the printer 100.

FIG. 7 is an explanatory diagram illustrating an operation of the recording unit 9 with respect to the first conveying unit 5 in the printer 100.

FIG. 8 is an explanatory diagram illustrating a recovery operation of the recording heads 17a to 17c in the printer 100.

FIG. 9 is an explanatory diagram illustrating the recovery operation of the recording heads 17a to 17c in the printer 100.

### DETAILED DESCRIPTION

### [1. Configuration of Ink-Jet Recording Apparatus]

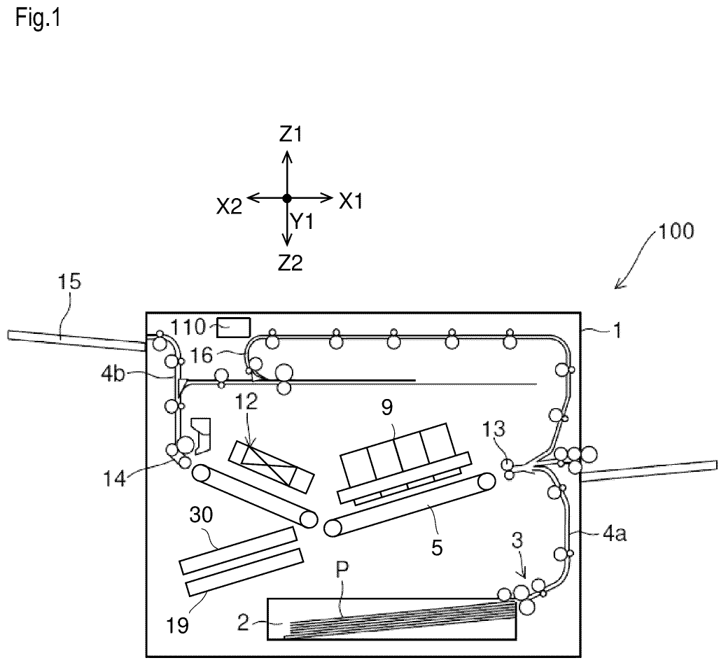

Hereinafter, a printer 100 (ink-jet recording apparatus; hereinafter referred to as printer 100) which is an embodiment of the present disclosure will be described with reference to the accompanying drawings. FIG. 1 is an explanatory diagram illustrating a schematic configuration of the printer 100 according to one embodiment of the present disclosure. As a matter of convenience of explanation, a vertical direction is defined as an up-and-down direction (Z1-Z2 direction) in an installation state (state illustrated in FIG. 1) in which the printer 100 can be used. Moreover, a front-back direction (Y1-Y2 direction) is defined as a direction of a front (front surface) side toward the drawing sheet of the printer 100 illustrated in FIG. 1. Furthermore, a left-right direction (X1-X2 direction) is defined as a reference of the front side of the printer 100 which is in the installation state. In the present embodiment, the left-right direction (X1-X2 direction) is orthogonal to the up-and-down direction (Z1-Z2 direction) and the front-back direction (Y1-Y2 direction).

The printer 100 includes a sheet feeding cassette 2 which is a sheet storage portion. The sheet feeding cassette 2 is disposed at a lower side inside a printer main body 1. Sheets P as an example of a recording medium is stored inside the sheet feeding cassette 2. A sheet feeding device 3 is disposed on a downstream side in a sheet conveying direction of the sheet feeding cassette 2, i.e., above the right (X1 side) of the sheet feeding cassette 2 in FIG. 1. With the sheet feeding device 3, the sheets P are separately fed out one after another toward an upper right of the sheet feeding cassette 2 in FIG. 1.

Moreover, the printer 100 includes a first sheet conveying passage 4a therein. The first sheet conveying passage 4a is located at an upper right side, which is a sheet feeding direction, of the sheet feeding cassette 2. The sheets P fed out from the sheet feeding cassette 2 are conveyed by vertically upward along a side surface of the printer main body 1 through the first sheet conveying passage 4a.

A pair of registration rollers 13 are provided at a downstream end of the first sheet conveying passage 4a with respect to the sheet conveying direction. Furthermore, a first belt conveying unit (conveying unit) 5 and a recording unit 9 are disposed immediately downstream of the pair of registration rollers 13 in the sheet conveying direction. The sheet P fed out from the sheet feeding cassette 2 reaches the pair of registration rollers 13 through the first sheet conveying passage 4a. The pair of registration rollers 13 temporarily stop the sheet P to correct skewed conveying thereof, and also coordinates timing of an ink ejecting operation executed by the recording unit 9 to reconveys the sheet P toward the first belt conveying unit (conveying unit) 5.

A second belt conveying unit 12 is disposed on a downstream side (left side X2 of FIG. 1) of the first belt conveying unit (conveying unit) 5 with respect to the sheet conveying direction. The sheet P on which an ink image is recorded by the recording unit 9 is conveyed to the second belt conveying unit 12, and the ink ejected onto a front surface of the sheet P is dried while the sheet passes through the second belt conveying unit 12.

A decurler unit 14 is provided on a downstream side of the second belt conveying unit 12 with respect to sheet conveying direction, i.e., near a left side surface of the printer main body 1. The sheet P on which the ink is dried by the second belt conveying unit 12 is conveyed to the decurler unit 14, and a curl generated on the sheet P is corrected using a plurality of rollers aligned in a sheet width direction.

A second sheet conveying passage 4b is provided on a downstream side of the decurler unit 14 (upper side in FIG. 1) with respect to the sheet conveying direction. The sheet P that has passed through the decurler unit 14 is, when no double-sided recording is performed, discharged from the second sheet conveying passage 4b to a sheet discharge tray 15 provided outside the left side surface of the printer 100 through a pair of discharge rollers.

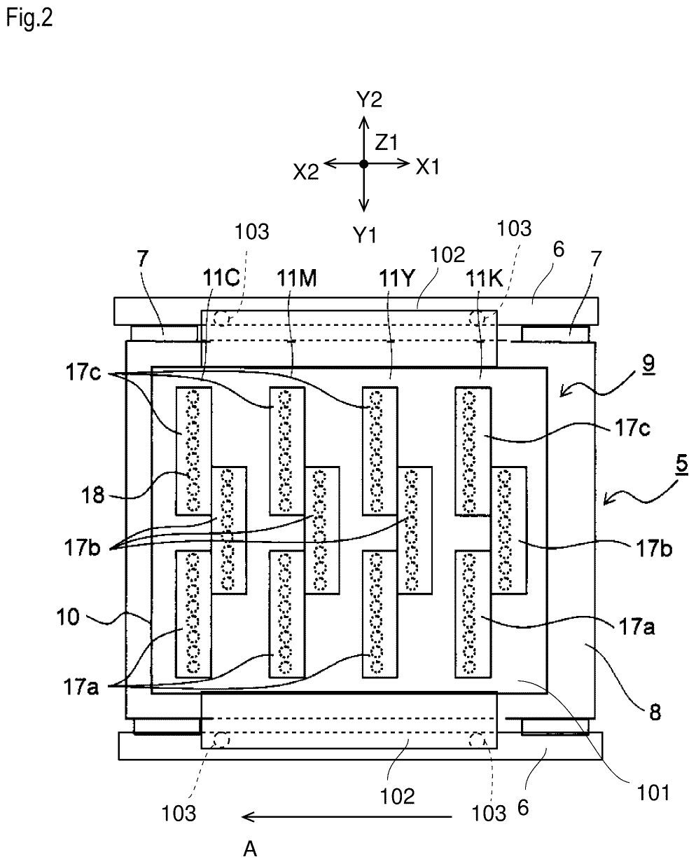

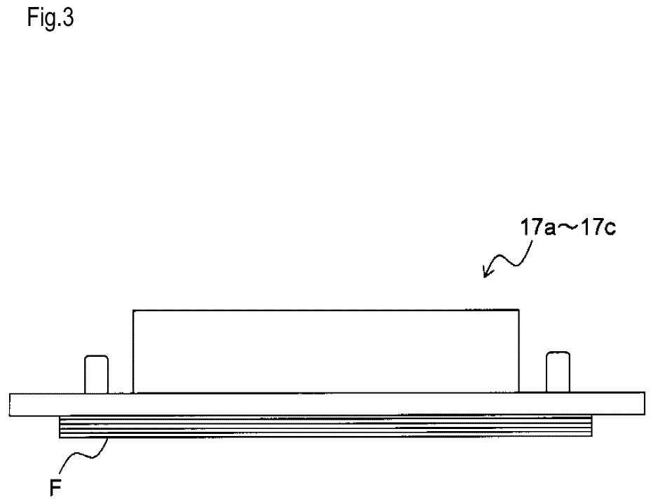

Moreover, a maintenance unit 19 and a cap unit 30 are disposed below the second belt conveying unit 12. The maintenance unit 19, when executing purging described below, moves below the recording unit 9, and wipes off the ink pushed out from ejection nozzles (nozzles) 18 (refer to FIG. 2) in the recording heads 17a to 17c described below and collects the wiped-off ink. The cap unit 30, when capping the ink ejection surface F of the recording heads 17a to 17c (refer to FIG. 3), moves below the recording unit 9 and then further moves upwards further to be attached to the lower surface of the recording heads 17a to 17c.

FIG. 2 is a diagram of the recording unit 9 in the printer 100 viewed from an upper side thereof. The recording unit 9 includes a head housing 10, and line heads 11C, 11M, 11Y, and 11K held by the head housing 10. The line heads 11C to 11K are held at a height as to keep a predetermined distance (e.g., 1 mm) from a conveying surface 8a of the first conveying belt (conveying belt) 8 stretched around a plurality of conveying rollers 7. The line heads 11C to 11K each include a plurality (herein, three pieces) of recording heads 17a to 17c arrayed in a staggered formation along the sheet width direction (Y1-Y2 direction) orthogonal to the sheet conveying direction (direction A). The line heads 11C to 11K each include a recording region equal to or greater than the width of the sheet P to be conveyed, and eject water-based ink (ink) from the ejection nozzles 18 onto the sheet P conveyed by the first conveying belt 8.

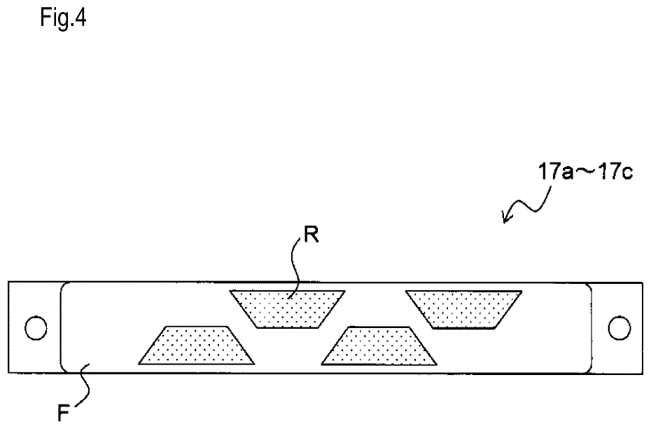

FIG. 3 is a side view illustrating a recording head 17 constituting one representative of the line heads 11C to 11K of the recording unit 9, and FIG. 4 is a plan view illustrating one representative of the recording heads 17a to 17c viewed from the ink ejection surface F side. Since the recording heads 17a to 17c have the same shape and configuration, FIGS. 3 and 4 illustrate one representative of the recording heads 17a to 17c. A nozzle region R in which a large number of ejection nozzles 18 are arrayed is provided on the ink ejection surface F of each the recording heads 17a to 17c. Moreover, a water-repellent film (not illustrated) is formed on the ink ejection surface F.

The recording heads 17a to 17c constituting each of the line heads 11C to 11K are supplied with ink of four colors (cyan, magenta, yellow, and black) stored in an ink tank (not illustrated) for each color of the line heads 11C to 11K.

Each of the recording head 17a to 17c ejects the ink from the ejection nozzles 18 onto the sheet P conveyed to be suctioned and held on a conveying surface of the first conveying belt 8, in accordance with image data received from an external computer. Consequently, a color image in which the four colors of ink, cyan, magenta, yellow, and black, are superimposed is formed on the sheet P conveyed on the first conveying belt 8.

In order to prevent ink ejection failure due to drying or clogging of the recording heads 17a to 17c, purging is performed to push out ink with high viscosity from the nozzles, e.g., from the ejection nozzles 18 of all recording heads 17a to 17c at the start of printing after a long period of inactivity, and from the ejection nozzles 18 of recording heads 17a to 17c of which amount of ink to be ejected is equal to or less than a specified value between printing operations, in preparation for the next printing operation.

### [2. Operation of Recording Unit 9 for First Conveying Unit 5]

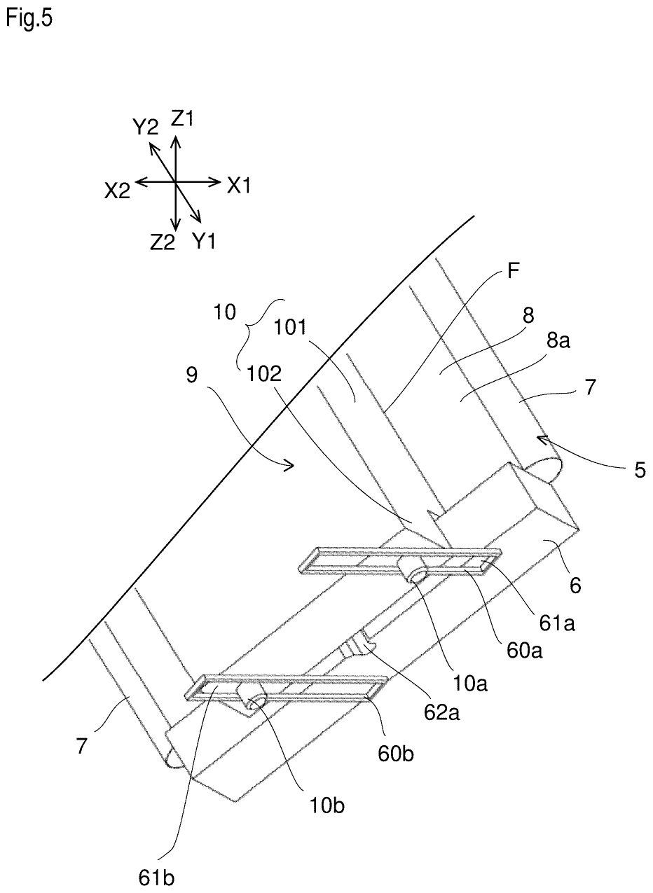

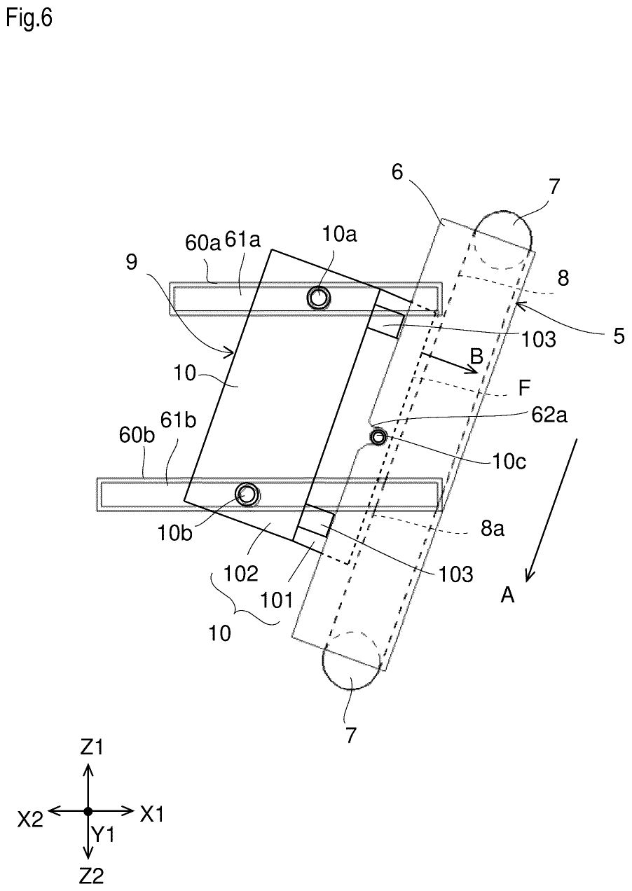

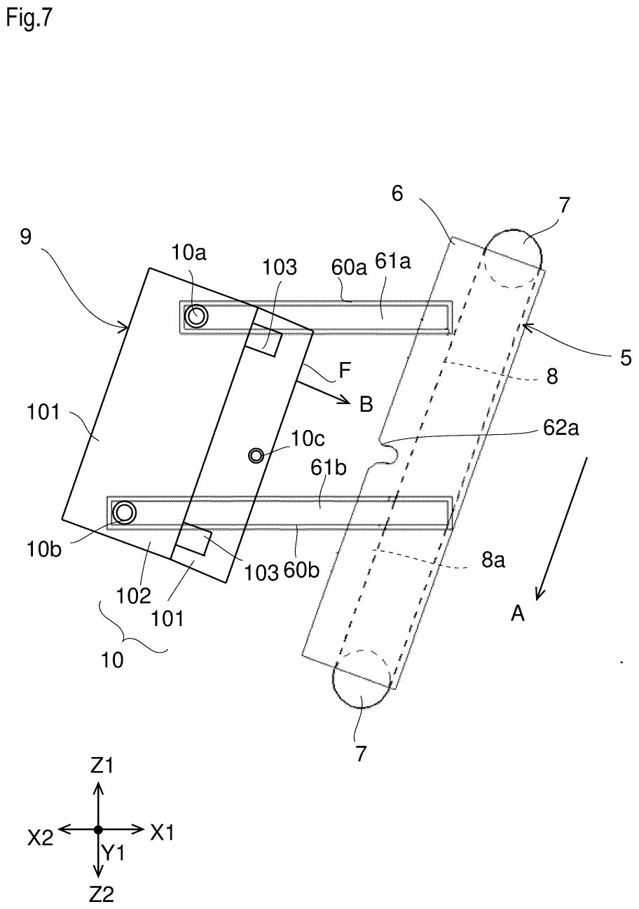

FIG. 5 is a perspective diagram illustrating a part of the first conveying unit (conveying unit) 5 and the recording unit 9. FIGS. 6 and 7 are explanatory diagrams illustrating an operation of the recording unit 9, which are cross-sectional diagrams orthogonal to an axial direction of the conveying roller 7 (Y1-Y2 direction). More specifically, FIG. 6 illustrates a state where the head housing 10 is in a printing position, and FIG. 7 illustrates a state where the head housing 10 is in a maintenance position. It is to be noted that, in the following exposition, the sheet width direction (Y1-Y2 direction) corresponds to the axial direction of the conveying roller 7.

In the present embodiment, the ink ejection surface F is disposed parallel to the conveying surface 8a of the first conveying belt 8. Moreover, the ink ejection surface F is inclined with respect to a horizontal direction (X1-X2 direction) in a cross section orthogonal to the axial direction (Y1-Y2 direction) of the conveying roller 7. Consequently, a space where the first conveying belt 8 and the head housing 10 are disposed can be narrowed in the right-left direction (X1-X2 direction), and thereby the printer 100 can be downsized in the right-left direction (X1-X2 direction).

The first conveying unit (conveying unit) 5 includes the first conveying belt (conveying belt) 8, the plurality of conveying rollers 7, and a roller housing 6. The first conveying belt 8 conveys the sheet (recording medium) P in the sheet conveying direction A. The first conveying belt 8 is stretched over the conveying rollers 7. A pair of the roller housings 6 are disposed on both outsides in the axial direction of the conveying roller 7 and are fixed to the printer main body 1. It is to be noted that the roller housings 6 may rotatably support the conveying rollers 7.

Each roller housing 6 includes a recessed portion 62a formed by being recessed in the horizontal direction from a surface that faces the head housing 10 in the horizontal direction. The recessed portion 62a is disposed to face a protruded region 10c, which will be described late, in the horizontal direction (X1-X2 direction).

Moreover, guide rails 60a and 60b extending in the horizontal direction are fixed to each roller housing 6. The guide rails 60a and 60b are disposed outside the axial direction of the first conveying belt 8, and respectively include guide holes 61a and 61b extending in the horizontal direction (X1-X2 direction).

The head housing 10 includes a main body portion 101 and side protruding portions 102. The main body portion 101 is quadrilateral viewed from an ejection direction B and stores the line heads 11C, 11M, 11Y, and 11K therein. In the present embodiment, an outer peripheral portion of the main body portion 101 is disposed inside the sheet width direction (Y1-Y2 direction) than the first conveying belt 8 (refer to FIG. 2).

The side surface protruding portions 102 respectively protrude outside the sheet width direction (Y1-Y2 direction) than the first conveying belt 8 from portions of both side surfaces in the sheet width direction (Y1-Y2 direction) of the main body portion 101 (refer to FIG. 2). The side protruding portions 102 include guide protruding portions 10a and 10b protruding respectively from the both side surfaces in the sheet width direction (Y1-Y2 direction). The guide protruding portions 10a and 10b are disposed parallel to the sheet conveying direction A. It is to be noted that, in the present embodiment, the side protruding portions 102 are provided, but such side protruding portions 102 may not be provided. In this case, the guide protruding portions 10a and 10b are directly provided respectively on the both side surfaces in the sheet width direction (Y1-Y2 direction) of the main body portion 101.

The guide protruding portion 10a is inserted inside the guide hole 61a, and the guide protruding portion 10b is inserted inside the guide hole 61b. Consequently, the head housing 10 is supported to be sandwiched by the pair of guide rails 60a and 60b from the sheet width direction (Y1-Y2 direction). Moreover, the guide protruding portions 10a and 10b respectively slide inside the guide hole 61a and 61b.

In other words, the guide rails 60a and 60b support the head housing 10 to be capable of reciprocating with respect to the first conveying belt (conveying belt). Moreover, by moving the head housing 10 along the guide rails 60a and 60b extending in the horizontal direction, the ink ejection surface F reciprocates between a printing position (refer to FIG. 6) close to a conveying surface 8a and a maintenance position (refer to FIG. 7) retracted from the conveying surface 8a.

Printing operation is executed when the head housing 10 is in the printing position. Water-based ink (ink) is ejected, by printing operation, from the ejection nozzles 18 into the sheet P conveyed by the first conveying belt 8. Moreover, when the head housing 10 is in the maintenance position, recovery operation of the recording head 17 is executed. In the recovery operation, the maintenance unit 19 moves below the head housing 10 being in the maintenance position. The recovery operation will be described in details later.

Moreover, on both side surface in the sheet width direction (Y1-Y2 direction) of the main body portion 101, a protruded region 10c is formed on the first conveying belt 8 side than the side protruding portion 102 (refer to FIGS. 6 and 7). A tip of the protruded region 10c protrudes outside the sheet width direction (Y1-Y2 direction) than the first conveying belt 8. A tip portion of the protruded region 10c is disposed to face the roller housing 6 in the horizontal direction (X1-X2 direction). When the ink ejection surface F is disposed in the printing position, the protruded region 10c is disposed in the recessed portion 62a. Consequently, the head housing 10 including the ink ejection surface F can be prevented from being shifted in the sheet conveying direction A.

Each side protruding portion 102 includes a protruding portion 103 protruding in the ink ejection direction B. Namely, the head housing 10 includes the protruding portion 103 protruding in the ink ejection direction B. Two protruding portions 103 are arranged in line on each side protruding portion 102 in the sheet conveying direction A. The protruding portion 103 is disposed to face the roller housing 6 in the horizontal direction (X1-X2 direction).

When the ink ejection surface F is disposed in the printing position, the protruding portion 103 is in contact with the roller housing 6, and holds constantly a distance (e.g., 1 mm) between the ink ejection surface F and the conveying surface 8a in the ejection direction B (refer to FIG. 6). Consequently, it is possible to prevent the distance between the ink ejection surface F and the conveying surface 8a from being shifted.

It is to be noted that timing at which the ejection nozzles (nozzles) 18 eject the ink onto the sheet (recording medium) P is preferably determined based on the distance between the ink ejection surface F and the conveying surface 8a when the ink ejection surface F is disposed in the printing position. Consequently, it is possible to prevent the printing performance from being decreased even if the distance between the ink ejection surface F and the conveying surface 8a is shifted when the head housing 10 is moved to the printing position from the maintenance position.

In addition, a drive motor (not illustrated) for moving the head housing 10 in the horizontal direction (X1-X2 direction) and a gear train (not illustrated) connected to the drive motor are provided on outside the guide rails 60a and 60b. As the drive motor rotates, the gear train rotates, and thereby the head housing 10 moves in the horizontal direction (X1-X2) between the printing position and the maintenance positions.

[3. Recovery Operation of Recording Heads 17a to 17c]

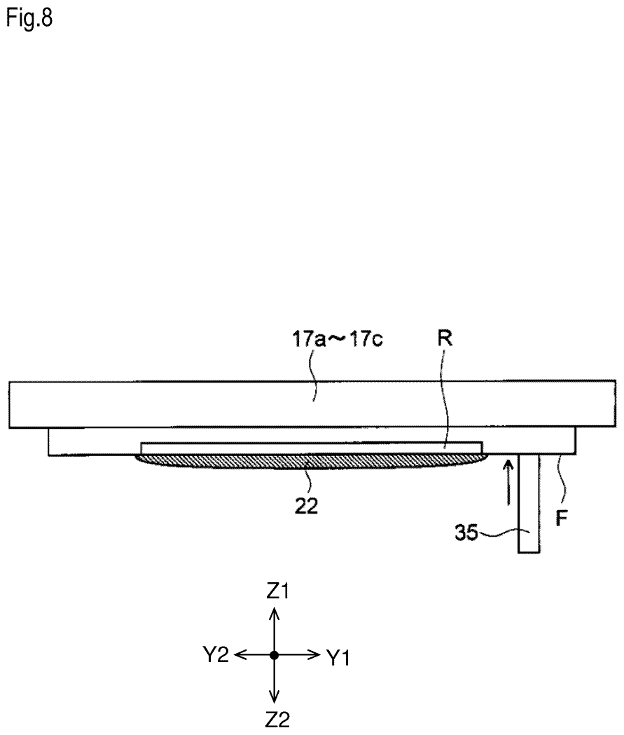

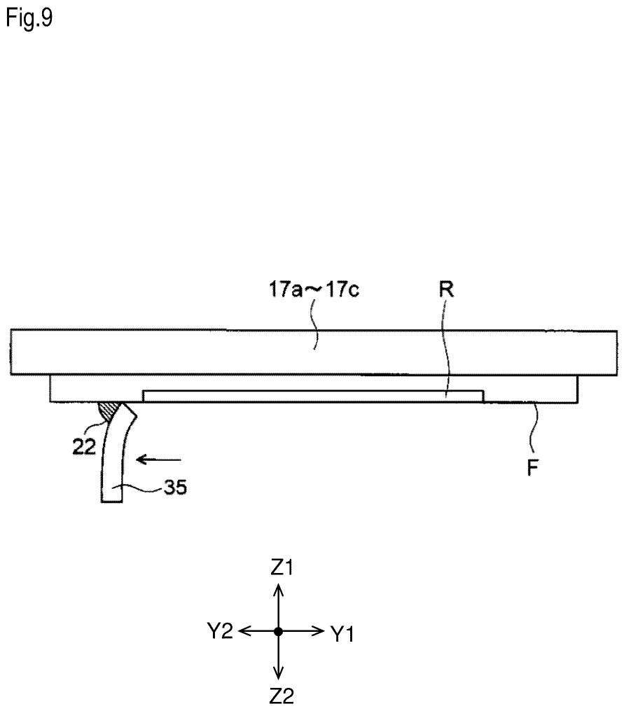

FIGS. 8 and 9 are explanatory diagrams illustrating a recovery operation of the recording heads 17a to 17c. In order to clean the ink ejection surfaces F of the recording heads 17a to 17c, the printer 100 executes a recovery operation for all the recording heads 17a to 17c at start of printing after a long period of suspension and between printing operations, in preparation for the next printing operation.

When executing the recovery operation for the recording head 17, the head housing 10 is moved from the printing position to the maintenance position, and the maintenance unit 19 is moved below the head housing 10 from a retract position (refer to FIG. 1).

Next, ink is supplied to the recording heads 17a to 17c. The supplied ink 22 is compulsorily pushed out (purged) from the ejection nozzles 18. Thickened ink, foreign matters, and air bubbles inside the ejection nozzle 18 are discharged by the purging operation, and thereby the recording heads 17a to 17c can be recovered.

Next, a wiping operation is executed to wipe off the ink 22 discharged onto the ink ejection surface F. Specifically, as illustrated in FIG. 8, a wiper 35 is brought into pressure contact with a wiping start position of the ink ejection surface F of each of the recording heads 17a to 17c by raising the maintenance unit 19 by a unit elevation mechanism.

Then, the wiper 35 wipes off the ink 22 pushed out onto the ink ejection surface F of each of the recording heads 17a to 17c. As illustrated in FIG. 9, after the wiper 35 moves to a downstream end of the ink ejection surface F of each of the recording heads 17a to 17c, the wiper 35 is retracted downward from the ink ejection surface F of each of the recording heads 17a to 17c.

Thereafter, the maintenance unit 19 is moved from below the head housing 10 to the retract position (refer to FIG. 1). Next, the head housing 10 is moved from the maintenance position to the printing position.

In addition, the present disclosure is not limited to each of the above-described embodiments, which thus allows for many modifications and variations without departing from the spirit of the present disclosure. For example, the number of the ejection nozzles 18 of the recording heads 17a to 17c, a distance between the nozzles, etc. can be set as appropriate in accordance with specifications of the printer 100. Moreover, the number of the recording heads is not particularly limited, and for example, one, two, or four or more recording heads 17 may be arranged for each line head 11C to 11K.

The present disclosure is applicable to ink-jet recording apparatuses including nozzles that eject water-based ink onto recording media.

What is claimed is:

1. An ink-jet recording apparatus comprising:
a conveying unit including a conveying belt configured to convey a recording medium, and a conveying roller over which the conveying belt is stretched;
a recording head includes an ink ejection surface provided with a plurality of nozzles configured to eject ink onto the recording medium conveyed by the conveying unit;
a head housing holding the recording head; and
a guide rail configured to support the head housing so that the head housing can reciprocate with respect to the conveying belt, wherein
the ink ejection surface is parallel to a conveying surface of the conveying belt,
the ink ejection surface is inclined with respect to a horizontal direction in a cross section orthogonal to an axial direction of the conveying roller, and
by moving the head housing along the guide rail extending in the horizontal direction, the ink ejection surface reciprocates between a printing position close to the conveying surface and a maintenance position retracted from the conveying surface.

2. The ink-jet recording apparatus according to claim 1, wherein
the conveying unit includes
a roller housing disposed outside the axial direction of the conveying roller, wherein
the head housing includes a protruding portion protruding in an ejection direction of the ink, and
when the ink ejection surface is disposed in the printing position, the protruding portion is in contact with the roller housing, and holds constantly a distance between the ink ejection surface and the conveying surface.

3. The ink-jet recording apparatus according to claim 1, wherein
the head housing includes a protruded region protruding in a width direction of the storage medium orthogonal to a conveying direction,
the roller housing includes a recessed portion formed by being recessed in the horizontal direction from a surface that faces the head housing, and,
when the ink ejection surface is disposed in the printing position, the protruded region is disposed in the recessed portion.

4. The ink-jet recording apparatus according to claim 1, wherein
timing at which the nozzles eject the ink onto the recording medium is determined based on a distance between the ink ejection surface and the conveying surface when the ink ejection surface is disposed in the printing position.
